(19) United States
(12) Patent Application Publication
(10) Pub. No.: US 2007/0143757 A1
(43) Pub. Date: Jun. 21, 2007

(54) Program product, operating system, compiler, and electronic device for reducing the power consumption

(75) Inventor: Osamu Chiba, Tokyo (JP)

Correspondence Address: LEYDIG VOIT & MAYER, LTD, 700 THIRTEENTH ST. NW, SUITE 300, WASHINGTON, DC, 20005-3960, US

(73) Assignee: Mitsubishi Electric Corporation, Tokyo (JP)

(21) Appl. No.: 11/471,605

(22) Filed: Jun. 21, 2006

(30) Foreign Application Priority Data
Dec. 16, 2005 (JP) 2005-363037

(51) Int. Cl. G06F 9/46

(52) U.S. Cl. 718/100

(57) ABSTRACT

If an interrupt occurs due to an interrupt factor during a user program execution, a control program product for a microcomputer changes the operating frequency. The control program product then executes a subroutine and performs an operating frequency restoration process. The operating frequency restoration process is a common process that is also performed when another subroutine is executed.

### BACKGROUND OF THE INVENTION

1. Field of the Invention

The present invention relates to a program product, an operating system, a compiler, and an electronic device, and more particularly to firmware for controlling a microcomputer incorporated for electronic device control, a program product for reducing the power consumption of computer software, an operating system, a compiler, and an electronic device.

2. Background Art

In Japanese Unexamined Patent Publication No. 2002-169790, built-in microcomputers for controlling recent electronic devices and microprocessors built in a personal computer or other computer are described, which incorporate an operating frequency change function for the purpose of reducing the power consumption of devices or permitting external calibration of the operating frequency.

The operating frequency change function is a function for dynamically changing the cycle of a basic operating clock, which is necessary for operations, when a microcomputer or microprocessor executes a particular machine language instruction (e.g., for writing an operating frequency value into an operating frequency setup register).

For instance, when an instruction for reducing the operating speed (e.g., for setting a low frequency value in an operating frequency setup register) is executed, a clock generation section (PLL, DLL, or other similar circuit) generates a clock in accordance with a newly set operating frequency. This extends the cycle of the basic operating clock.

When the cycle is extended as described above, a relatively low basic operating clock is supplied to an electronic circuit constituting a microcomputer or microprocessor. This decreases the number of switchings (CMOS circuit charging/discharging count) per unit time of a transistor constituting an electronic circuit, thereby reducing the power consumption.

On the other hand, when an instruction for raising the operating speed (e.g., for setting a high frequency value in an operating frequency setup register) is executed, the cycle of the basic operating clock is shortened. When the cycle of the basic operating clock is shortened, the frequency of the basic operating clock supplied to an electronic circuit rises. This increases the number of switchings per unit time of a transistor constituting a microcomputer or microprocessor. Consequently, the electronic circuit operates at a high speed and increases its power consumption per unit time.

The time required for instruction execution is determined by the above-mentioned number of transistor switchings (CMOS circuit charging/discharging count). Therefore, when the number of transistor switchings per unit time increases, the computation speed substantially increases.

In recent years, it is demanded that electronic devices for microprocessors and microcomputers reduce their power consumption. The following function is employed to meet such a demand. For example, during an interval during which no instruction needs to be executed (during an idle period), a microprocessor or microcomputer receives an idle instruction from an OS (operating system). When such a condition persists for a predetermined period of time, a sleep/standby function works to lower the operating clock of the microprocessor or microcomputer for power saving purposes.

In a sleep state described above, the microprocessor or microcomputer begins to monitor for an event (external interrupt) or other similar restoration instruction from the OS (operating system) with a view toward reverting to a normal operation speed. Upon receipt of such an event or restoration instruction, the microprocessor or microcomputer reverts to a normal operating clock, resumes the execution of a user program, and returns to a normal operation state.

When the above microprocessor or microcomputer is used, the software manufacturer cannot arbitrarily control the operating speed of the software to be executed. Therefore, when power management is to be exercised, an operating frequency control function offered by microprocessor or microcomputer hardware or by an operating system is used.

The memory space (memory area) available for control program execution is limited particularly for a microcomputer or microprocessor that is built in an electronic device for electronic device control purposes. Therefore, there are many cases where an operating system is not used. Consequently, the power consumption can be reduced only by using a sleep function offered by microcomputer hardware.

Since only a limited memory area was available for the aforementioned conventional microcomputer and the like and for the execution of a program product for controlling such hardware, it was difficult to arbitrarily control the operating frequency. As a result, the software that can be operated at a low speed and the software that needs to be operated at a high speed were executed at a normal operating speed (except in a sleep/standby state). Thus, constructive power management could not be exercised for power consumption reduction purposes.

### SUMMARY OF THE INVENTION

The present invention has been developed to solve the above-described problems, and therefore it is an object of the present invention to provide a program product, operating system, compiler, and electronic device that are capable of reducing the memory area for control program execution, causing a control program to exercise constructive power management, and decreasing the power consumption of an electronic device.

The above object is achieved by a program for causing a computer to execute a process for executing a user program at a first frequency, a frequency change process for changing the first frequency to an arbitrary frequency when an interrupt occurs due to an arbitrary one of a plurality of interrupt factors while the user program is being executed, a subroutine execution process for executing a subroutine corresponding to the arbitrary interrupt factor at the arbitrary frequency, a frequency restoration process for switching from the arbitrary frequency to the first frequency, and a process for resuming the execution of the user program at the first frequency, wherein, the frequency restoration process is a common process that is performed after the execution of a subroutine corresponding to one of the plurality of interrupt factors.

The present invention makes it possible to obtain a program product, operating system, compiler, and electronic device that are capable of reducing the memory area for control program product execution, causing a control program product to exercise constructive power management, and decreasing the power consumption of an electronic device.

Other features and advantages of the invention will be apparent from the following description taken in connection with the accompanying drawings.

### BRIEF DESCRIPTION OF DRAWINGS

FIG. 1 shows a flowchart illustrating a control program product operation of the first and second embodiments;

FIG. 2 shows a chronological chart indicates some of the processing steps of the first embodiment;

FIG. 3 shows a chronological chart indicates some of the processing steps of the second embodiment;

FIG. 4 shows a structure of a program stack;

FIG. 5 shows a structure of a user data stack;

FIG. 6 shows shape of waves when a PLL or DLL changes its oscillation frequency;

FIG. 7 shows a flowchart illustrating a control program product operation of the third embodiment; and

FIG. 8 shows a flowchart illustrating a control program product operation of the fourth embodiment.

### DETAILED DESCRIPTION OF THE PREFERRED EMBODIMENTS

Embodiments of the present invention will be described below referring to the drawings. In the drawings, the same or equivalent parts will be denoted by the same reference numerals, and the description thereof will be simplified or omitted.

### First Embodiment

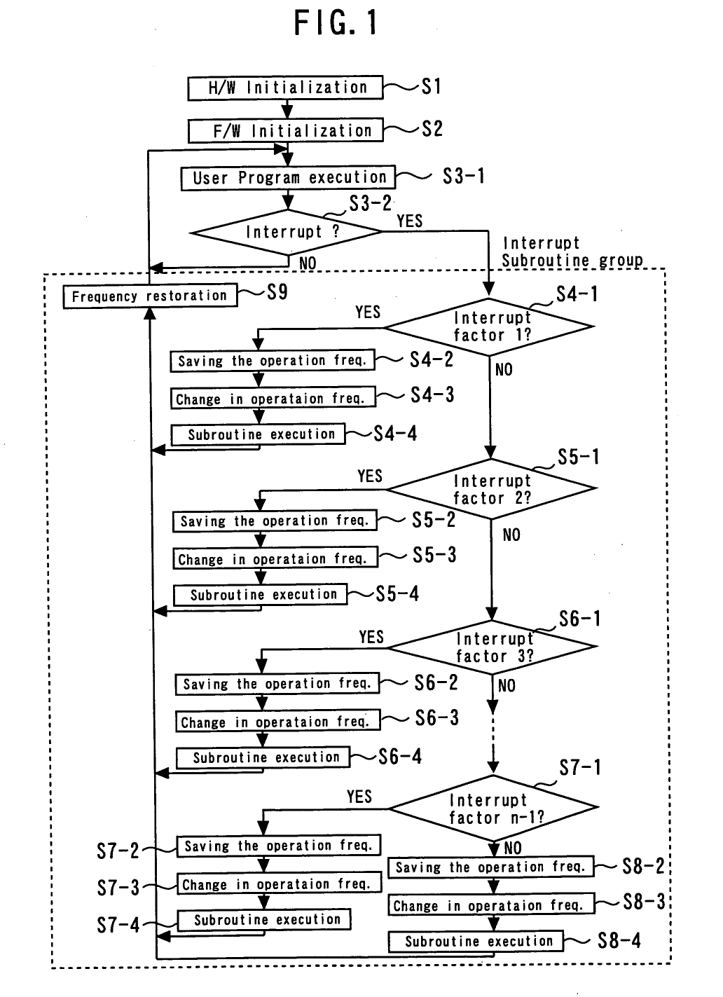

A program product (software) according to a first embodiment of the present invention is incorporated in a microcomputer (or microprocessor). The microcomputer is mounted in hardware that is a target device for embedding. FIG. 1 is a flowchart illustrating a control program product operation that is performed when such hardware is used. Individual processing steps will be described below.

When the hardware is turned ON or an explicit initialization instruction is issued by an external reset switch or the like, step S1 is performed to initialize the hardware (H/W) Next, step S2 is performed to initialize the firmware (F/W) of the microcomputer.

More specifically, step S2 is performed, for instance, to set various judgment information and constants for later use in a user program and define acceptable interrupt factors. Step S2 is also performed in order to set operating frequency information that determines the processing capacity to be provided by user program execution.

In a register (not shown) that determines the operating frequency, for example, a first frequency, which is half a rated operating frequency, is set. In this instance, the microcomputer operates at half the rated operating frequency until the interrupt handling process to be performed begins. This ensures that the microcomputer operates at low power consumption as compared to a situation where the microcomputer operates at the rated operating frequency.

Next, step S3-1 is performed to execute a user program at the aforementioned first frequency. Step S3-2 is then followed to judge whether an interrupt is generated during step S3-1. If the obtained judgment result indicates that no interrupt is generated, the flow returns to step S3-1 and continues with the execution of the user program. On the other hand, if the obtained judgment result indicates that an interrupt is generated, the flow proceeds to step S4-1 and formulates an interrupt factor 1 judgment for interrupt subroutines. This step need not always be performed by software or firmware. It may alternatively be performed by hardware built in the microcomputer.

When the flow proceeds from step S3-2 to step S4-1, a check is performed to judge whether the interrupt factor is 1. If the obtained judgment result indicates that the interrupt factor is not 1, the flow proceeds to step S5-1, which is performed for interrupt factor 2 judgment. On the other hand, if the obtained judgment result indicates that the interrupt factor is 1, the flow proceeds to step S4-2 and saves the operating frequency. A case where the flow proceeds from step S4-1 to S4-2 and a case where the flow proceeds from step S4-1 to S5-1 will be described below.

First of all, a case where the flow proceeds from step S4-1 to S4-2 will be described. In this case, step S4-2 is performed to save the current operating frequency information about the microcomputer. In this instance, the register information indicating the microcomputer's operating frequency is saved in a work register (temporary storage area). This ensures that the microcomputer's operating frequency setting information (half the rated operating frequency) prevailing before the generation of an interrupt is properly saved. In this step, the microcomputer operates at a low frequency, that is, at half the rated operating frequency, because the microcomputer's operating frequency is not changed.

In step S4-2, the address of a program for resuming the user program, which has been executed, is stored at the lowest level (not shown) of a program stack. This operation may be performed by either microcomputer hardware or control firmware.

Next, step S4-3 is performed to set a new operating frequency for the purpose of complying with an execution speed for a subroutine that is executed later. More specifically, operating frequency information is set in a register that determines the operating frequency for subroutine execution. In this step, the operating frequency information is changed from the first frequency, that is, half the rated operating frequency, to twice the rated operating frequency. This ensures that the newly set operating frequency is used for subsequent subroutine execution.

Next, step S4-4 is performed to execute a subroutine that corresponds to interrupt factor 1. In this step, the new operating frequency given in step S4-3 is used to execute machine language instructions that constitute the subroutine. In other words, the power consumption is increased; however, the operating frequency is increased to enhance the processing capacity and provide high-speed execution.

Subsequently, the operating frequency information saved in step S4-2 then reverts to a state prevailing at the time of user program execution (step S3-1). In other words, a frequency restoration step (step S9) is performed after the execution of the subroutine associated with interrupt factor 1 so that the operating frequency changes from twice the rated operating frequency to half the rated operating frequency (first frequency).

In step S9, the operating frequency information saved in step S4-2 is restored in relation to the register that determines the microcomputer's operating frequency. The microcomputer operating at a high frequency then operates at the frequency prevailing before the frequency change process, that is, at half the rated operating frequency (first frequency), thereby reducing the power consumption of the device.

When the operating frequency restoration process is performed in step S9, it is assumed that an interrupt handling process is completed. As a result, the process performed by the user program reverts to an address value (which is obtained by adding the value 1 to a user program address at which an interrupt occurred) that is indicated by a stack pointer and saved in a stack area (not shown). The user program execution step (step S3-1) is then resumed for continuation. In this instance, the user program is executed at half the rated operating frequency.

Next, a case where the flow proceeds from step S4-1 to S5-1 will be described. When the flow proceeds from step S4-1 to S5-1, a check is performed to judge whether the interrupt factor is 2. If the obtained judgment result indicates that the interrupt factor is 2, the flow proceeds to step S5-2 in which the operating frequency is saved. In this instance, step 5-2, which is for saving the operating frequency, step S5-3, which is for setting a new operating frequency, and step S5-4, which is for executing a subroutine, are performed as is the case with steps S4-2 to S4-4. Next, step S9 is performed. The flow then returns to step S3-1. On the other hand, if the obtained judgment result indicates that the interrupt factor is not 2, the flow proceeds to step S6-1, which formulates an interrupt factor 3 judgment.

If it is subsequently judged that a specific interrupt factor is encountered, the same processing steps are performed as steps S4-2 to S4-4. Then, step S9 is performed. Eventually, the flow returns to step S3-1. On the other hand, if it is judged that a specific interrupt factor is not encountered, the flow proceeds to step S6-1 or S7-1 in which a check is performed to judge whether the next interrupt factor is encountered.

If no specific interrupt factor is encountered when all the interrupt factor judgment steps (steps S4-1, S5-1, S6-1, and S7-1) are performed, step S8-2 is performed to save the current operating frequency information about the microcomputer. Subsequently, step S8-3, which sets a new operating frequency, and step S8-4, which executes a subroutine, are sequentially performed.

Steps S8-2, S8-3, and S8-4 are performed under default conditions where no predefined interrupt factors are encountered. Basically, the same processing steps are performed as steps S4-2 to S4-4. Then, step S9 is performed. Eventually, the flow returns to step S3-1.

In other words, when an interrupt occurs during user program execution due to one of a plurality of interrupt factors, the program product (control program) performs a process for changing the operating frequency setting from the first frequency (half the rated operating frequency) to a frequency for executing a subroutine corresponding to an encountered interrupt factor. After the subroutine is executed, the program product performs the common frequency restoration process (step S9) to switch from a changed frequency to the previous frequency. The use of this configuration makes it possible to reduce the memory area that the program product uses. This ensures that the program product is capable of dynamically changing the operating frequency. Consequently, the program product makes it possible to exercise constructive power management.

Further, if an interrupt occurs while the user program is being executed at the first frequency, which is lower than the rated operating frequency, the subroutine is executed with the operating frequency changed from the first frequency to a frequency higher than the rated operating frequency. This ensures that the power consumption can be reduced during user program execution, and that a frequency necessary for executing a subroutine can be set when the subroutine is to be executed. Furthermore, the operating frequency can properly revert to the frequency for user program execution after completion of subroutine execution. It is therefore possible to exercise power consumption management with high efficiency.

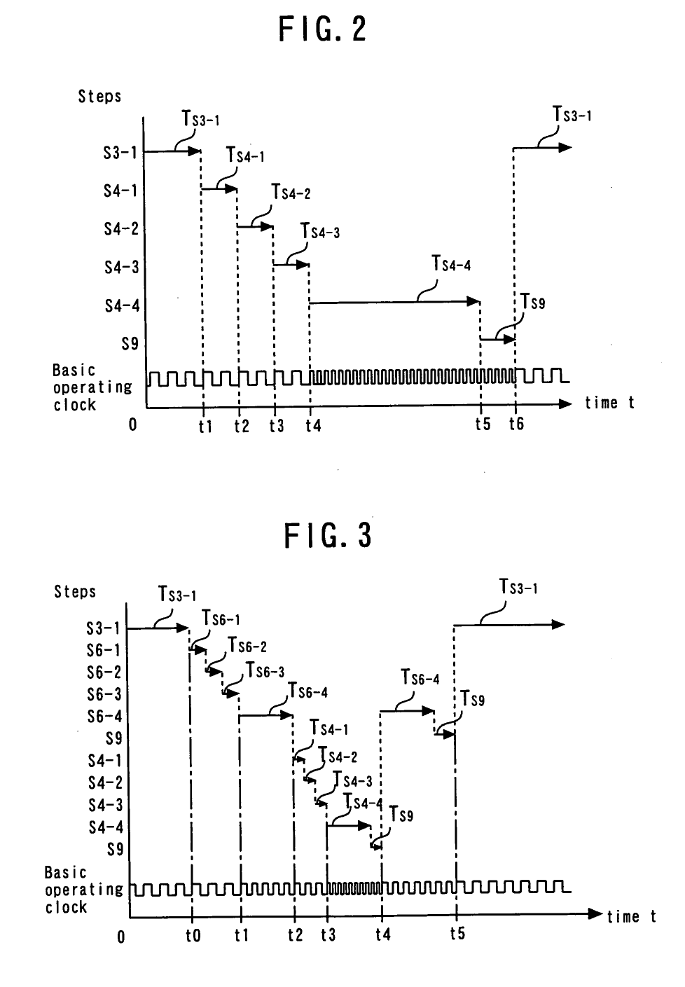

FIG. 2 chronologically indicates some of the processing steps shown in FIG. 1. The description given below relates to a situation where an interrupt occurs due to interrupt factor 1 during the user program execution step (step S3-1), a subroutine corresponding to the interrupt is executed, and then the user program resumes.

Within a series of operations indicated in FIG. 1, the user program execution step (step S3-1), the interrupt generation judgment step (step S3-2), the interrupt factor 1 judgment step (step S4-1), the operating frequency save step (step S4-2), the operating frequency setup step (step S4-3), the subroutine execution step (step S4-4), the operating frequency information restoration step (step S9), and the resumption of the user program execution step (step S3-1) are sequentially performed.

With the time for starting the user program execution step (step S3-1) regarded as time 0, FIG. 2 indicates the basic operating clocks for the period Ts₃₋₁ between time 0 and time t₁ (step S3-1), the period Ts₄₋₁ between time t₁ and time t₂ (step S4-1), the period Ts₄₋₂ between time t₂ and time t₃ (step S4-2), the period Ts₄₋₃ between time t₃ and time t₄ (step S4-3), the period Ts₄₋₄ between time t₄ and time t₅ (step S4-4), the period Ts₉ between time t₅ and time t₆ (step S9), and the period Ts₃₋₁ beyond time t₆ (step S3-1).

During execution periods Ts₃₋₁, Ts₄₋₁, Ts₄₋₂, and Ts₄₋₃, the program product operates at half the rated operating frequency. Therefore, the basic operating clock cycle is two times the cycle prevailing when the operation is performed at the rated operating frequency. During execution periods Ts₄₋₄ and Ts₉, on the other hand, the program product operates at twice the rated operating frequency. Therefore, the basic operating clock cycle is half the cycle prevailing when the operation is performed at the rated operating frequency. Consequently, the basic operating clock cycle prevailing during the periods for the subroutine execution step (step S4-4) and operating frequency information restoration step (step S9) is one-fourth the basic operating clock cycle prevailing during the other execution periods.

As described above, the microcomputer's operating speed can be variously set for each of the subroutines constituting the program product. Upon completion of a subroutine execution, it is possible to revert to a state prevailing before subroutine execution. Consequently, constructive power management can be exercised.

### Second Embodiment

A program product according to a second embodiment of the present invention will now be described. The difference between the first and second embodiments will be mainly described. The description of the first embodiment assumes that a single interrupt occurs during user program execution. On the other hand, the description of the second embodiment assumes that multiple interrupts occur during user program execution. The basic operational flow of the second embodiment will not be described herein because it is the same as for the first embodiment (see FIG. 1).

FIG. 3 chronologically indicates some of the processing steps. The description given below relates to a situation where two interrupts occur, that is, an interrupt occurs due to interrupt factor 3 during the user program execution step (step S3-1), and then another interrupt occurs due to interrupt factor 1.

With the time for starting the user program execution step (step S3-1) regarded as time 0, FIG. 3 indicates the basic operating clocks for the period Ts₃₋₁ between time 0 and time t₀ (step S3-1), the execution periods Ts₆₋₁, Ts₆₋₂, Ts₆₋₃ between time t₀ and time t₁ (steps S6-1, S6-2, and S6-3), the period Ts₆₋₄ between time t₁ and time t₂ (step S6-4), the periods Ts₄₋₁, TS₄₋₂, TS₄₋₃ between time t₂ and time t₃ (steps S4-1, S4-2, and S4-3), the periods Ts₄₋₄, Ts₉ between time t₃ and time t₄ (steps S4-4 and S9), the periods Ts₆₋₄, Ts₉ between time t₄ and time tₛ (steps S6-4 and S9), and the period Ts₃₋₁ beyond time t₅ (step S3-1).

In a multiple interrupt handling process described above, the interrupt level setting for interrupt factor 1 is higher than that for interrupt factor 3. Therefore, a subroutine execution process (step S4-4) corresponding to interrupt factor 1 can be performed by interrupting a subroutine execution process (step S6-4) corresponding to interrupt factor 3.

When the multiple interrupt handling process is to be performed, it is necessary to store the information about the address for program product resumption and the value of the operating frequency. This storage operation is performed by a stack pointer. The operation performed by the stack pointer will be described below.

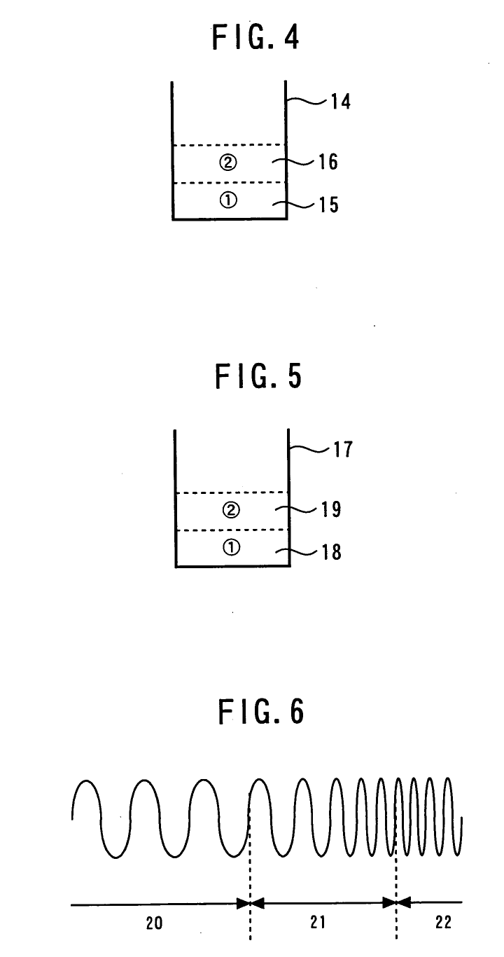

FIG. 4 illustrates the structure of a program stack that stores the address information about user program resumption. The structure includes a stack area 14 for the program. When an address pointer is saved due to the first interrupt, the pointer indicating the address for resuming the currently executed user program is stored in storage location 15. When address information is saved due to the second interrupt, the pointer indicating the address for resuming the currently executed program product is stored in storage location 16. In other words, after a currently executed subroutine is interrupted, the address for resuming the interrupted subroutine is stored in storage location 16 of a hierarchically structured stack area. This ensures that the interrupted subroutine resumes from the address stored in storage location 16.

FIG. 5 illustrates the structure of a user data stack that stores a frequency value for operating frequency value restoration. The illustrated structure is the same as that of the program stack shown in FIG. 4 so that the operating frequency information can be hierarchically saved. This structure includes a stack area 17 for storing the operating frequency information. When the operating frequency information is saved due to the first interrupt, the saved information is stored in storage location 18. When the operating frequency information is saved due to the second interrupt, the saved information is stored in storage location 19. In other words, after a currently executed subroutine is interrupted, the frequency value to be used for resuming an interrupted subroutine is stored in storage location 19 of a hierarchically structured data area. This ensures that the interrupted subroutine resumes at a frequency whose value is stored in storage location 19.

The operational flow of the multiple interrupt handling process shown in FIG. 3 will now be described with reference to FIG. 1. First of all, steps S1 and S2 are performed in the same manner as described in conjunction with the first embodiment. Next, the user program execution step (step S3-1) is performed. This step is repeatedly performed until a timer overflow, external interrupt, or other interrupt occurs (e.g., steps S4-1, S5-1, S6-1, and S7-1). This step is performed in accordance with the operating frequency information that was set in step S2 (in a low power consumption mode in which the operating frequency is low).

If an interrupt corresponding to interrupt factor 3 occurs, the interrupt factor judgment step (step S6-1) is performed. In this instance, an interrupt disable flag is set. The interrupt disable flag is generally set by hardware. Interrupts encountered after the interrupt disable flag is set are stored on an interrupt queue and will not be executed until interrupts are enabled.

When an interrupt occurs, the stack pointer (the place for storing an address pointer indicating the restoration destination after completion of interrupt handling) is positioned in storage location 15, which is shown in FIG. 4. The stack pointer position is determined by adding the value 1 to a user program address for execution immediately before the interrupt.

Next, the operating frequency information save process (step S6-2) is performed. This process is also performed at the operating frequency that was set in step S2 (in a low power consumption mode in which the operating frequency is low). In this step, too, the interrupt disable flag remains set. In this instance, the saved operating frequency value is stored in storage location 18, which is shown in FIG. 5.

Next, the step for setting new operating frequency information (step S6-3) is performed. This step is also performed at the operating frequency that was set in step S2 (in a low power consumption mode in which the operating frequency is low).

In this step (step S6-3), the rated operating frequency (a rated power consumption mode in which the operating frequency is medium) is set as the operating frequency for step S6-4, which is the next step (for executing the subroutine associated with interrupt factor 3). The operating frequency information set in this step takes effect after completion of this step. In this step, too, the interrupt disable flag remains set.

Next, step S6-4 is performed to execute the subroutine associated with interrupt factor 3. In this step, the microcomputer operates at the rated operating frequency that was set in the preceding step, that is, step S6-3 (in a rated power consumption mode in which the operating frequency is medium).

At the beginning of this step (step S6-4), the interrupt disable flag is cleared in order to handle multiple interrupts during this step. The flag can be cleared by means of software, that is, by using an assembler (machine language instruction). When the flag is cleared in this manner, interrupts having higher priority than interrupt factor 3 can be generated.

Next, an arbitrary program code (assembler programs defined as subroutines) is executed. The following description relates to an operation that is performed when interrupt factor 1, which has higher priority than interrupt factor 3, arises while a subroutine associated with interrupt factor 3 is executed.

If, for instance, an interrupt occurs due to interrupt factor 1 during period Ts₆₋₄, which is shown in FIG. 3, the program address for current execution (step S6-4) is incremented by one and then stored in storage location 16, which is shown in FIG. 4. The reason is that storage location 15 is already used for the interrupt factor judgment step (step S6-1) and that the incremented value is stored above storage location 15 (stacked).

After the above address value is stored, the flow proceeds to step S4-2. Instep S4-2, the currently set operating frequency information for the microcomputer is saved. More specifically, the value set in the associated register is stored in storage location 19, which is shown in FIG. 5. The reason is that storage location 18 is already used for the operating frequency save step (step S6-2) and that the value set in the register is stored above storage location 18 (stacked).

The structure for storing the operating frequency information (user data stack structure), which is shown in FIG. 5, is a first-in last-out structure as is the case with a program stack structure (see FIG. 4). In other words, the operating frequency information stored in storage location 19 is taken out before the operating frequency information that was put in storage location 18 (see FIG. 5) earlier than the operating frequency information stored in storage location 19.

The above-mentioned operating frequency save process (step S4-2) is also performed at the rated operating frequency (in a medium power consumption mode). Further, the interrupt disable flag remains set.

Next, the process for setting a new operating frequency (step S4-3) is performed. In this step, an operating frequency higher than the rated operating frequency is set because the operating frequency for the subsequently performed process is higher than the rated operating frequency (in a high power consumption mode). While this step (step S4-3) is being performed, the operation is performed at a medium operating frequency (in a rated power consumption mode), and the interrupt disable flag remains set.

Next, step S4-4 is performed. At the beginning of this step, the interrupt disable flag is cleared. This step, which executes the subroutine associated with interrupt factor 1, is performed at an operating frequency that was set in the preceding step (step S4-3).

The second embodiment is described for the purpose of explaining about the operation performed when multiple interrupts occur. Therefore, the operation performed when further interrupts occur will not be described.

Next, the operating frequency restoration process (step S9) is performed. In this step, the operating frequency information saved in storage location 19, which is shown in FIG. 5, is stored in a register (not shown) for determining the microcomputer's operating frequency. Further, a reference address pointer addition process is performed (to ensure that storage location 18, which is shown in FIG. 5, is properly referenced when it is referenced next).

As is the case with step S4-4, step S9 is performed in a high power consumption mode in which the operating frequency is high. In steps subsequent to step S9, the frequency stored in storage location 19, which is shown in FIG. 5, is used so that the operation is performed in a rated power consumption mode in which the operating frequency is medium.

When step S9 is performed, a series of interrupt handling processes associated with interrupt factor 1 is completed. Therefore, a program stack operation is performed to copy the address information stored in storage location 16, which is shown in FIG. 4, to a program counter, and a reference address pointer addition process is performed (to ensure that storage location 15, which is shown in FIG. 4, is properly referenced when it is referenced next).

When the above interrupt reset process is performed, the microcomputer, which has performed the process associated with interrupt factor 1, resumes step S6-4 (subroutine process corresponding to interrupt factor 3), which was performed before an interrupt occurrence. In this instance, the basic operating clock information used for the process for handling interrupt factor 3 is properly restored. Therefore, the power consumption of the microcomputer can be reduced as intended.

The microcomputer, which has resumed step S6-4, executes the associated subroutine in accordance with a defined machine language program stream. The microcomputer executes all the instructions defined for step S6-4, and then proceeds to step S9.

In step 9, the frequency restoration process is performed. The process is performed so that the frequency information, which determines the microcomputer's operating frequency and is saved in storage location 18 (see FIG. 5), is restored to the associated register. In this instance, the value of the frequency information is equal to the frequency value (in a low power consumption mode in which the operating frequency is low) that was used in the user program execution step (step S3-1), which was performed before the execution of interrupt factor 3.

Therefore, when the operating frequency information in storage location 18, which is shown in FIG. 5, is restored, the previously executed code can be properly executed at an intended speed (the user program execution can be properly resumed at an intended speed). As is the case with step S6-4, this step (step S9) is performed in a rated power consumption mode in which the operating frequency is medium.

When step S9 is performed to complete the operating frequency information restoration process, the microcomputer begins to operate at the newly selected operating frequency. More specifically, the microcomputer operates in a low power consumption mode in which the operating frequency is low. This processing speed is exactly the same as that was used before interrupt factor 3 arose.

In the second embodiment, the order of priority is defined for the interrupt factors shown in FIG. 1. When a subroutine corresponding to a specific interrupt factor is being executed and an interrupt corresponding to a second interrupt factor having higher priority than the specific interrupt factor occurs (when multiple interrupts are encountered), the execution of the subroutine corresponding to the specific interrupt factor is halted. Then, the subroutine corresponding to the higher priority interrupt factor is executed. After the execution of the subroutine corresponding to the higher priority interrupt factor is terminated, the halted subroutine execution resumes. In this instance, the address for program resumption and the operating frequency information for resumption are respectively stored in stack-structured areas. This ensures that the second embodiment provides the same advantages as the first embodiment even when multiple interrupts occur.

As described above, the present embodiment makes it possible to exercise constructive power management even when multiple interrupts occur.

The present embodiment (second embodiment) has been described on the assumption that two interrupts are generated. However, when the stack structure shown in FIGS. 4 and 5 is modified to increase the number of stackable storage locations, the present embodiment can properly operate to handle two or more multiple interrupts.

### Third Embodiment

A program product according to a third embodiment of the present invention will now be described. The difference between the third embodiment and the first and second embodiments will be mainly described. The description of the first and second embodiments assumes that no process is performed on the period of frequency stabilization time for an oscillator (re-lock time for a PLL (Phase Locked Loop) oscillator and DLL (Delay Locked Loop) oscillator), which is required for an operating frequency change. In the first and second embodiments, therefore, the microcomputer operation is likely to become unstable while the operating frequency (reference clock) varies.

FIG. 6 illustrates an operation that is performed when a PLL or DLL changes its oscillation frequency. In FIG. 6, waveform 20 prevails before an oscillation frequency change (low frequency=stable), and waveform 22 prevails after an oscillation frequency change (high frequency=stable). Waveform 21 in FIG. 6 is an oscillation frequency waveform that prevails during a re-lock period, that is, during a period between a period before the oscillation frequency change and a period after the oscillation frequency change.

FIG. 6 indicates that a PLL, DLL, or other similar oscillator sequentially changes its oscillation frequency. In an actual oscillator, however, such a change is not always smooth as indicated in the figure (because it depends, for instance, on the characteristic of a feedback circuit).

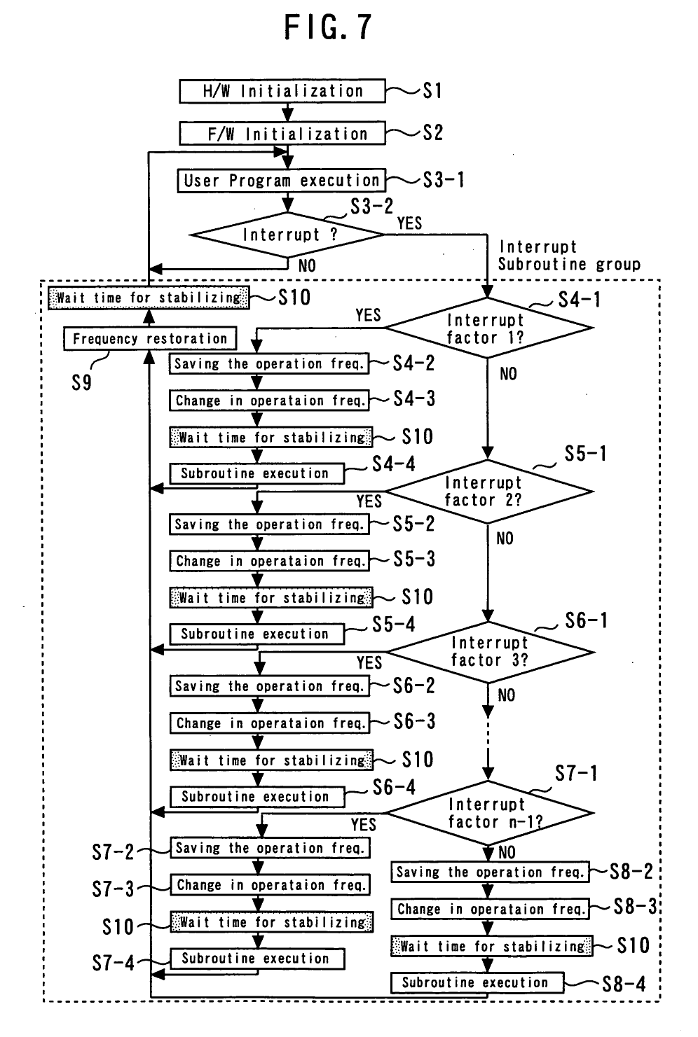

As indicated in FIG. 7, the third embodiment is provided with step S10, which is performed between steps S4-3 and S4-4 and between steps S9 and S3-1. Step S10 is performed to obtain a wait time for stabilizing a reference clock operation. For example, step S10 is performed to process an NOP (No Operation) instruction. More specifically, a process is performed to obtain a wait time for stabilizing a reference clock operation during an interval between a frequency change process corresponding to a specific interrupt factor and the associated subroutine execution process, and between a frequency restoration process and a user program execution resumption process. The other elements of configuration are the same as for the first embodiment.

The insertion count of the above NOP instruction may be proportional to the required stabilization time (the number of clocks required for stabilization) when the operating frequency is changed with an oscillator (PLL, DLL, or other similar oscillator) that is used with the microcomputer. This re-lock time can be quantitatively determined in accordance with the characteristic of an employed oscillator (PLL, DLL, or other similar oscillator) and the amount of variation it provides.

In an example shown in FIG. 7, the process for obtaining the wait time for stabilizing the reference clock operation (step S10) is performed during an interval between a frequency change process (step S4-3, S5-3, S6-3, S7-3, or S8-3) and a subroutine execution process corresponding to the frequency change process, and during an interval between a frequency restoration process (step S9) and a process for resuming a user program execution (step S3-1). However, the effect is independently produced even when step S10 is performed during one of the above-mentioned intervals.

Therefore, when it is demanded that the microcomputer perform a stable operation, the NOP instruction is inserted in accordance with the cycle obtained during a period (equivalent to the number of clocks required for stabilization) that is calculated from the above characteristic. This ensures that the microcomputer performs a stable operation even when the operating frequency is dynamically changed.

More specifically, the NOP instruction execution cycle for a RISC microcomputer can be regarded as 1 instruction/1 cycle (1 clock). Therefore, the purpose is achieved when the NOP instruction is inserted in accordance with the number of cycles equivalent to the re-lock period of a PLL, DLL, or other similar oscillator, which is determined from the above characteristic.

As regards a CISC microcomputer, the number of NOP instructions to be inserted can be calculated by dividing the number of cycles equivalent to the re-lock period of a PLL, DLL, or other similar oscillator, which is determined from the above characteristic, by the number of execution cycles required for NOP instruction processing.

When the NOP instruction is inserted in accordance with the third embodiment, it is possible to avoid a situation where a primary process is performed during a period during which the reference operating clock of the microcomputer is unstable. Consequently, the third embodiment not only provides the advantages offered by the first and second embodiments, but also enhances the stability of microcomputer operations.

### Fourth Embodiment

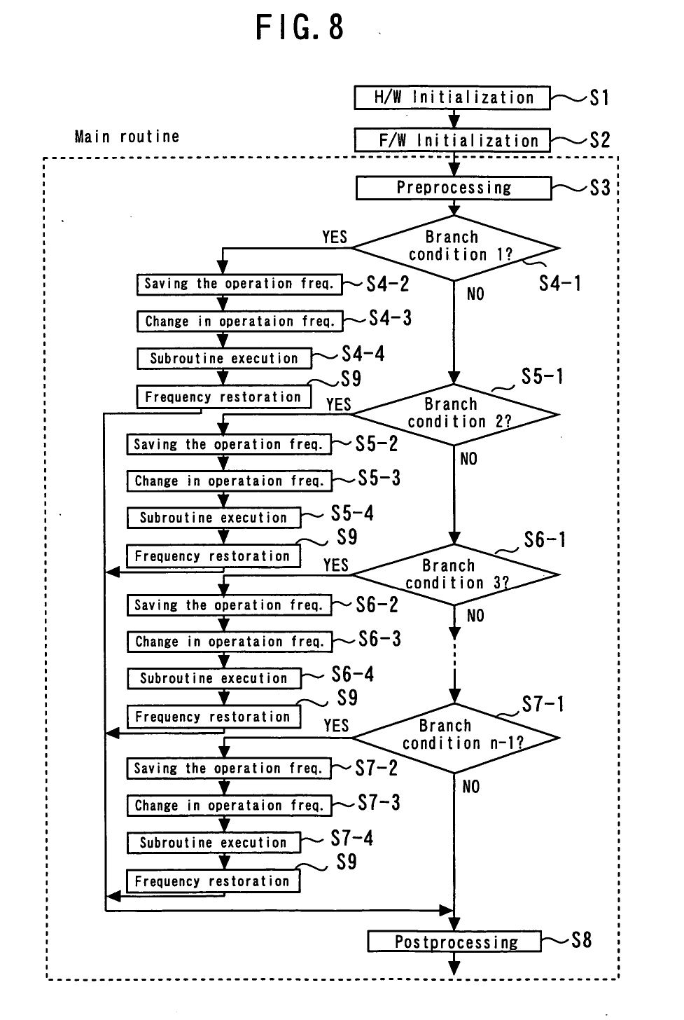

FIG. 8 is a flowchart illustrating an operation that is performed by a program product according to a fourth embodiment of the present invention. The difference between the fourth embodiment and the first to third embodiments will be mainly described. The program product according to the fourth embodiment defines the interrupt factors used in the first to third embodiment as branch conditions. When it is judged that a branch condition is met, the program product according to the fourth embodiment performs the same processes (operating frequency save, operating frequency setup, and subroutine execution processes) as indicated in the flowchart for the first embodiment. After the execution of a subroutine, the operating frequency restoration process is performed independently and incidentally to the subroutine.

First of all, steps S1 and S2 are performed in the same manner as indicated in the flowchart for the first embodiment. Then, a main routine process is performed. After completion of step S2, a preprocessing step (step S3) is performed. Further, a branch condition 1 judgment step (step S4-1) is performed. When it is judged that branch condition 1 is met, the operating frequency save step (step S4-2), operating frequency setup step (step S4-3), and subroutine execution step (S4-4) are performed. Next, an independent operating frequency restoration step (step S9), which is incidental to a subroutine, is performed. After completion of step S9, a postprocessing step (step S8) is performed.

If branch condition 1 is not met, subsequent branch condition judgment processes are performed until a certain branch condition is met. If none of branch conditions 1 to n−1 are met, the postprocessing step (step S8) is performed. If any branch condition is met, the operating frequency save, operating frequency setup, and subroutine execution steps are performed. Then, the operating frequency restoration step (step S9), which is incidental to the executed subroutine, is performed. After completion of step S9, a postprocessing step (step S8) is performed.

In the first embodiment, the operating frequency restoration process (step S9) is a common process that is performed subsequently to the execution of a subroutine corresponding to one of a plurality of interrupt factors (see FIG. 1). In the fourth embodiment, on the other hand, the operating frequency restoration process is performed after the execution of a subroutine corresponding to one of a plurality of interrupt factors independently and incidentally to the executed subroutine.

Since the employed configuration is as described above, the program product according to the fourth embodiment involves a larger number of steps than the program product according to the first embodiment (the program size of the fourth embodiment is larger than that of the first embodiment). However, the fourth embodiment does not have to use a jump instruction (perform an addition/subtraction process on a counter indicating the program product execution address) for program product sharing in step S9. As a result, the response of the program product can be enhanced.

The program product indicated in the operational flowchart of the third embodiment may be combined with the program product according to the third embodiment. More specifically, the response of the program product can be enhanced when an incidental operating frequency restoration process is performed independently after the execution of a subroutine within the operational flowchart shown in FIG. 7.

### Fifth Embodiment

A fifth embodiment of the present invention will now be described. The descriptions of the first to fourth embodiments relate to the operation of a program product incorporated in the microcomputer. Meanwhile, the description of the fifth embodiment relates to an operation that is performed on an operating system level.

Only the operating frequency information about the microcomputer, which is used for subroutine execution, is stored at the beginning of a subroutine that is to be executed due, for instance, to an interrupt factor.

When an operating system detects an interrupt, not shown, it automatically performs an operating frequency save process (e.g., step S4-2, S5-2, S6-2, S7-2, or S8-2 in FIG. 1) that the first to fourth embodiments perform on an individual subroutine basis. The operating system also exercises control over the operating frequency information to be saved and its storage destination.

When the operating system completes the above operating frequency save process, it passes processing to subroutine execution. An operating frequency setup instruction, which is used for subroutine execution, is stored at the beginning of each subroutine. Therefore, when any subroutine is executed, the operating frequency automatically changes.

After completion of a subroutine execution, it is necessary to perform the operating frequency restoration process. Therefore, the operating system needs to automatically achieve operating frequency restoration.

As regards the restoration process execution timing, the operating system can detect an event that is generated when an interrupt process is cleared (completed). Therefore, when such an event is detected, the saved operating frequency information should be restored. The definite restoration method and the effect of restoration are the same as with the first to fourth embodiments.

In other words, the fifth embodiment differs from the first to fourth embodiments in that the former causes the operating system to perform the frequency change process and frequency restoration process. When the operating system is provided with a computer incorporating the program product according to the first, second, third, or fourth embodiment, the operating system can provide the same advantages as those offered by the first to fourth embodiments. Even when an electronic device incorporates the program product according to the first, second, third, or fourth embodiment, it can provide the same advantages as those offered by the first to fourth embodiments.

According to the fifth embodiment, the operating frequency used by a currently executed code can be saved and restored by the operating system. Therefore, the amount of code for subroutines can be reduced. Further, the fifth embodiment can handle multiple interrupts as is the case with the second embodiment.

### Sixth Embodiment

A sixth embodiment of the present invention will now be described. The descriptions of the first to fourth embodiments relate to the operation of the microcomputer and the program product incorporated in the microcomputer (mainly the machine language instructions) as well as the development technique (programming technique). However, when development is to be performed with a high-level language (e.g., C-language or Basic language), it is very difficult to apply the development technique.

Therefore, when a process is inserted with a compiler for translating a high-level language program into a machine language program, it is possible to provide the same advantages as the first to fifth embodiments.

More specifically, the above purpose can be achieved by furnishing a program product developer (compiler user) with a capability for inserting or changing an instruction for defining the program product execution speed by using individual functions constituting a subroutine.

In an actual process, however, a desired effect is not produced if the total number of clocks required for executing a subroutine associated with an interrupt condition is not larger than the total number of clocks required for the operating frequency save process and setup process, which are performed before and after a subroutine execution.

After subroutines written in a high-level language are translated into a machine language (assembler), therefore, the compiler performs a process for calculating the number of clocks required for individual subroutine executions by using the configuration type (RISC or CISC) and processing capacity (number of cycles required for individual instruction executions) of the employed microcomputer (or microprocessor).

If the calculated number of clocks is larger than the number of clocks required for the operating frequency save process and restoration process, which are performed before and after the execution of the subroutine translated into a machine language, it is deemed that the effect of processing capacity improvement or power consumption reduction is produced. Before a subroutine execution, the instructions for saving the operating frequency and setting a new operating frequency are issued. After a subroutine execution, the machine language instruction for operating frequency restoration is automatically inserted.

On the other hand, if the calculated number of clocks is smaller than the number of clocks required for the operating frequency save process and restoration process, which are performed before and after the execution of the subroutine translated into a machine language, it is deemed that the effect of processing capacity improvement or power consumption reduction is not produced. In this instance, an error message or the like is conveyed to the user (program product developer), and the associated instruction stream is not inserted.

In other words, if it is deemed that the effect of processing capacity improvement or power consumption reduction is produced by an actual process when the program product according to the first, second, third, or fourth embodiment is translated from a high-level language to a machine language, the compiler according to the sixth embodiment can insert a frequency change instruction for the operating frequency change process and operating frequency restoration process into a machine language.

Even when the operating frequency changes on an individual subroutine basis, the sixth embodiment ensures that the processing capacity and power consumption are constantly optimized.

Obviously many modifications and variations of the present invention are possible in the light of the above teachings. It is therefore to be understood that within the scope of the appended claims the invention may by practiced otherwise than as specifically described.

The entire disclosure of a Japanese Patent Application No. 2005-363037, filed on Dec. 16, 2005 including specification, claims, drawings and summary, on which the Convention priority of the present application is based, are incorporated herein by reference in its entirety.

1. A program product for causing a computer to execute:
a process for executing a user program at a first frequency;
a frequency change process for changing the first frequency to an arbitrary frequency, when an interrupt occurs due to an arbitrary one of a plurality of interrupt factors, while the user program is being executed;
a subroutine execution process for executing a subroutine corresponding to the arbitrary interrupt factor at the arbitrary frequency;
a frequency restoration process for switching from the arbitrary frequency to the first frequency; and
a process for resuming execution of the user program at the first frequency, wherein the frequency restoration process is a common process that is performed after execution of a subroutine corresponding to one of the plurality of interrupt factors.

2. The program product according to claim 1, wherein the first frequency is lower than a rated frequency, and the arbitrary frequency is higher than the rated frequency.

3. The program product according to claim 1, wherein, if an interrupt occurs due to the arbitrary interrupt factor, the first frequency is saved before the frequency change process, and the arbitrary frequency is used as the first frequency during the frequency restoration process.

4. The program product according to claim 2, wherein, if an interrupt occurs due to the arbitrary interrupt factor, the first frequency is saved before the frequency change process, and the arbitrary frequency is used as the first frequency during the frequency restoration process.

5. The program product according to claim 1, wherein
an order of priority is defined for the plurality of interrupt factors;
if an interrupt corresponding to a second interrupt factor, which has higher priority than a first interrupt factor, occurs during execution of a first subroutine corresponding to the first interrupt factor, the first subroutine is interrupted to execute a second subroutine, which corresponds to the second interrupt factor; and
the execution of the first subroutine resumes after completion of the execution of the second subroutine.

6. The program product according to claim 2, wherein
an order of priority is defined for the plurality of interrupt factors;
if an interrupt corresponding to a second interrupt factor, which has higher priority than a first interrupt factor, occurs during execution of a first subroutine corresponding to the first interrupt factor, the first subroutine is interrupted to execute a second subroutine, which corresponds to the second interrupt factor; and
the execution of the first subroutine resumes after completion of execution of the second subroutine.

7. The program product according to claim 3, wherein
an order of priority is defined for the plurality of interrupt factors;
if an interrupt corresponding to a second interrupt factor, which has higher priority than a first interrupt factor, occurs during execution of a first subroutine corresponding to the first interrupt factor, the first subroutine is interrupted to execute a second subroutine, which corresponds to the second interrupt factor; and
the execution of the first subroutine resumes after completion of execution of the second subroutine.

8. The program product according to claim 4, wherein
an order of priority is defined for the plurality of interrupt factors;
if an interrupt corresponding to a second interrupt factor, which has higher priority than a first interrupt factor, occurs during execution of a first subroutine corresponding to the first interrupt factor, the first subroutine is interrupted to execute a second subroutine, which corresponds to the second interrupt factor; and
the execution of the first subroutine resumes after completion of execution of the second subroutine.

9. The program product according to claim 5, wherein
after the first subroutine is interrupted, an address for resuming execution of the the first subroutine is stored in a hierarchically structured stack area, and
the execution of the first subroutine resumes at the stored address.

10. The program product according to claim 6, wherein
after the first subroutine is interrupted, an address for resuming execution of the the first subroutine is stored in a hierarchically structured stack area, and
the execution of the first subroutine resumes at the stored address.

11. The program product according to claim 7, wherein
after the first subroutine is interrupted, an address for resuming execution of the the first subroutine is stored in a hierarchically structured stack area, and
the execution of the first subroutine resumes at the stored address.

12. The program product according to claim 8, wherein
after the first subroutine is interrupted, an address for resuming execution of the the first subroutine is stored in a hierarchically structured stack area, and
the execution of the first subroutine resumes at the stored address.

13. The program product according to claim 5, wherein
the first subroutine is executed at an arbitrary frequency;
the arbitrary frequency is stored in a hierarchically structured data area after the execution of the first subroutine is interrupted; and
the execution of the first subroutine resumes at the stored arbitrary frequency.

14. A program product for causing a computer to execute:
a process for executing a user program at a first frequency;
a frequency change process for changing the first frequency to an arbitrary frequency, when an interrupt occurs due to an arbitrary one of a plurality of interrupt factors, while the user program is being executed;
a subroutine execution process for executing a subroutine corresponding to the arbitrary interrupt factor at the arbitrary frequency;
a frequency restoration process for switching from the arbitrary frequency to the first frequency; and
a process for resuming execution of the user program at the first frequency, wherein the frequency restoration process is an independent process that is performed after execution of a specific subroutine corresponding to one of the plurality of interrupt factors.

15. The program product according to claim 1, wherein a process for acquiring a wait time for stabilizing a reference clock operation is performed during an interval between the frequency change process and the subroutine execution process or between the frequency restoration process and the process for resuming the execution of the user program.

16. The program product according to claim 14, wherein a process for acquiring a wait time for stabilizing a reference clock operation is performed during an interval between the frequency change process and the subroutine execution process or between the frequency restoration process and the process for resuming the execution of the user program.

17. A program product for causing a computer to execute:
a process for executing a user program at a first frequency;
a frequency change process for changing the first frequency to an arbitrary frequency, when an interrupt occurs due to an arbitrary one of a plurality of interrupt factors, while the user program is being executed;
a subroutine execution process for executing a subroutine corresponding to the arbitrary interrupt factor at the arbitrary frequency;
a frequency restoration process for switching from the arbitrary frequency to the first frequency; and
a process for resuming execution of the user program at the first frequency, wherein
the frequency restoration process is a common process that is performed after execution of a subroutine corresponding to one of the plurality of interrupt factors, and
frequency change process and the frequency restoration process are performed by an operating system.

18. An operating system provided with a computer that incorporating a program product, wherein the program product comprises:
a process for executing a user program at a first frequency;
a frequency change process for changing the first frequency to an arbitrary frequency, when an interrupt occurs due to an arbitrary one of a plurality of interrupt factors, while the user program is being executed;
a frequency restoration process for switching from the arbitrary frequency to the first frequency; and
a process for resuming execution of the user program at the first frequency, wherein the frequency restoration process is a common process that is performed after execution of a subroutine corresponding to one of the plurality of interrupt factors.

19. A compiler for translating the program product from a high-level language to a machine language and inserting a frequency change instruction into the machine language, wherein the program product comprises:
a process for executing a user program at a first frequency;
a frequency change process for changing the first frequency to an arbitrary frequency, when an interrupt occurs due to an arbitrary one of a plurality of interrupt factors, while the user program is being executed;
a subroutine execution process for executing a subroutine corresponding to the arbitrary interrupt factor at the arbitrary frequency;
a frequency restoration process for switching from the arbitrary frequency to the first frequency; and
a process for resuming execution of the user program at the first frequency, wherein the frequency restoration process is a common process that is performed after execution of a subroutine corresponding to one of the plurality of interrupt factors.

20. An electronic device comprising:
means for executing a user program at a first frequency;
frequency change means for changing the first frequency to an arbitrary frequency, when an interrupt occurs due to an arbitrary one of a plurality of interrupt factors, while the user program is being executed;
subroutine execution means for executing a subroutine corresponding to the arbitrary interrupt factor at the arbitrary frequency;
frequency restoration means for switching from the arbitrary frequency to the first frequency; and
means for resuming execution of the user program at the first frequency, wherein the frequency restoration is performed after execution of a subroutine corresponding to one of the plurality of interrupt factors.
